(19) United States
(12) Patent Application Publication
(10) Pub. No.: US 2002/0076973 A1
(43) Pub. Date: Jun. 20, 2002

(54) Configuration for forming a contact between a component of an engine or transmission and an electrical printed ciruit board

(76) Inventors: Karl Smirra, Wasserburg (DE); Michael Thorum, Lake Orion, MI (US)

Correspondence Address: LERNER AND GREENBRG, P.A., Post Office Box 2480, Hollywood, FL, 33022-2480, US

(21) Appl. No.: 09/968,602

(22) Filed: Oct. 1, 2001

(30) Foreign Application Priority Data
Sep. 29, 2000 (DE) 100 48 457.3

(51) Int. Cl. H01R 13/56

(52) U.S. Cl. 439/446

(57) ABSTRACT

The connector system enables forming electrical contact between an electrical component and a support that is formed with a base body on which a flexible printed circuit board is attached. A contact spring is provided on the electrical component. A stop element which is provided above the flexible printed circuit board at a distance from the base body is shaped in such a way that it presses the contact spring against the flexible printed circuit board as it is moved closer to it. However, the build-up of a contact pressure force does not start until the contact zone of the contact spring is already located above the flexible printed circuit board.

### BACKGROUND OF THE INVENTION

Field of the Invention

The invention relates to a configuration for forming an electrical contact between an electrical component of an engine or transmission, in particular a solenoid valve, and a flexible printed circuit board which is secured to a base body and extends to an edge of the base body.

Flexible printed circuit boards are increasingly being used to distribute signals and current in the transmissions and engines of motor vehicles. For example, it is possible to provide a single flexible printed circuit board for making electrical contact to the sensors, actuators and integrated electronic control unit in a transmission.

When electrical contact is made with the flexible printed circuit board by so-called press-on contacts it is difficult to ensure that the necessary electrical contact is made with the electrical component that is reliable and stable in the long term. This is due to the fact that extreme ambient conditions (temperatures between −40° C. and 140° C. and vibration accelerations up to 33 g) are experienced in the transmission and a flexible printed circuit board can easily be damaged by mechanical effects such as friction loading in the contacting region.

In order to avoid contact problems, for this reason it is necessary to press a contact spring with a defined relatively high pressure onto a conductor track region (contact pad) of the flexible printed circuit board. The latter, if appropriate, is metallized.

The necessary high pressing-on force results in a situation wherein the damage may already occur to the printed circuit board when the electrical component is being mounted if the printed circuit board extends essentially parallel to the mounting direction, that is, when the contact spring is pushed laterally onto the printed circuit board. In such a case, the printed circuit board can be compressed or pushed away by the contact spring during the installation procedure.

In addition, the electrical component may be twisted around its main axis (which extends in the mounting direction) during mounting and even in the installed state of the electrical component owing to manufacturing and installation tolerances and the aforementioned vibrations. As a result, the pressing-on force of the contact spring on the printed circuit board is undesirably either increased or reduced.

A further difficulty is that there are metal turnings in the surrounding medium (transmission oil/engine oil) which in the most unfavorable case can lead to adjacent contacts short-circuiting.

U.S. Pat. No. 5,447,288 (German patent application DE 43 24 781 A1) discloses a plug-in solenoid valve whose electrical terminals which are provided on the outside of the valve element are embodied as spring contacts. Electrical contact is made by means of a contact pin of the spring element, which is oriented in the plug-in direction and which presses with its end side against a corresponding contact with a defined pressure.

German published patent application DE 197 25 289 A1 describes an electro-hydraulic pressure regulating valve which is anchored in an opening of a securing plate. In order to make electrical contact with the valve, a printed circuit board is provided which extends adjacent to the hydraulic valve on the securing plate and with which contact is made from above by means of contact spring elements provided on the valve body.

U.S. Pat. No. 5,807,126 (European patent application EP 0 840 399 A2) describes a low-profile multiple plug whose electrical plug contacts located one next to the other or embodied as spring elements which are deflected onto contact faces of the printed circuit board during the plugging-in procedure by means of a plug-in connector housing arranged above a printed circuit board.

### SUMMARY OF THE INVENTION

It is accordingly an object of the invention to provide a system for contacting an engine or transmission component to a conductor plate, which overcomes the above-mentioned disadvantages of the heretofore-known devices and methods of this general type and which provides for a configuration that is capable of reliably preventing damage to the flexible printed circuit board during the installation procedure of the electrical component.

With the foregoing and other objects in view there is provided, in accordance with the invention, a configuration for forming a contact between an electrical component and a flexible printed circuit board secured on a base body and extending to an edge of the base body, the configuration comprising:

a plug-in connector housing attached to the base body and having a housing opening formed toward the edge of the base body;

a contact spring formed with a contact zone for making contact with the printed circuit board, the contact spring supported on the electrical component and defining a mounting direction wherein the contact spring and the flexible printed circuit board are brought together when assembling the configuration, the mounting direction extending substantially parallel to a plane of the printed circuit board;

a stop element disposed on the plug-in connector housing above the flexible printed circuit board and shaped to engage over the contact spring as the contact spring is moved toward the stop element and to press the contact spring onto the flexible printed circuit board, whereby, during insertion of the contact spring into the housing opening, a pressure on the contact zone of the contact spring is substantially not built up until the contact zone is already located above the flexible printed circuit board, and

the plug-in connector housing having side walls dimensioned to straddle the contact spring substantially free of play.

The assembly is particularly suitable for, and it can be specifically dimensioned and configured to support a component of an engine or a transmission, such as a solenoid valve.

In other words, the stop element is shaped in such a way that when the contact spring reaches the flexible printed circuit board it either does not press on it at all or presses on it with only a minimum initial pressure and the actual pressing-on force, which is required to make secure contact with the printed circuit board, is not generated until later—to be specific when the contact spring has already passed the edge of the printed circuit board. As a result, the risk of the printed circuit board being “pushed away” by the contact spring is avoided. In addition, the plug-in connector housing is dimensioned in such a way that the side walls surround the contact spring essentially without play. This has the effect of enabling rotation of the electrical component to exert only a very small influence on the pressing-on force of the contact spring because the spring is (also) held in position by the side walls of the plug-in connector housing.

In this “box-shaped” plug-in connector housing, an advantageous embodiment variant of the invention is defined by the fact that the contact spring has a U-shaped profile.

In accordance with an added feature of the invention, the stop element is preferably the cover part of the plug-in connector housing attached to the base body.

In accordance with an additional feature of the invention, the stop element protrudes beyond the edge of the base body. As a result, it is possible to bring about a relatively large distance between the point at which the contact spring is deflected by the stop element and the contact zone, as a result of which a gentle build up pressure is made possible with respect to the displacement path occurring during the mounting operation.

In accordance with another feature of the invention, the stop element and the contact spring are provided with interacting latching means of complementary design. The latching means additionally stabilize and secure the contact spring in position in the plug-in connector housing.

In accordance with a concomitant feature of the invention, a closure element, which completely closes off the plug-in opening of the plug-in connector housing in the assembled state, is provided in the base region of the contact spring. The closure element forms the protection for the contact against metal turnings.

Other features which are considered as characteristic for the invention are set forth in the appended claims.

Although the invention is illustrated and described herein as embodied in Configuration for making contact between a component of an engine or transmission and an electrical printed circuit board, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a perspective view of a base body with a flexible printed circuit board which is applied as a lamination, and a plug-in contact housing attached to the base body;

FIG. 2 is a schematic end view of the structure illustrated in FIG. 1, viewed in the mounting direction;

FIG. 3 is a partial, schematic sectional view taken along the line III-III in FIG. 2;

FIG. 4 is a schematic sectional view of the configuration according to the invention prior to assembly;

FIG. 5 is a schematic sectional view of the configuration according to the device during assembly;

FIG. 6 is a schematic sectional view of the configuration according to the invention in the assembled state; and

FIG. 7 is a schematic, perspective phantom view of a contact spring in the plug-in connector housing.

### DESCRIPTION OF THE PREFERRED EMBODIMENTS

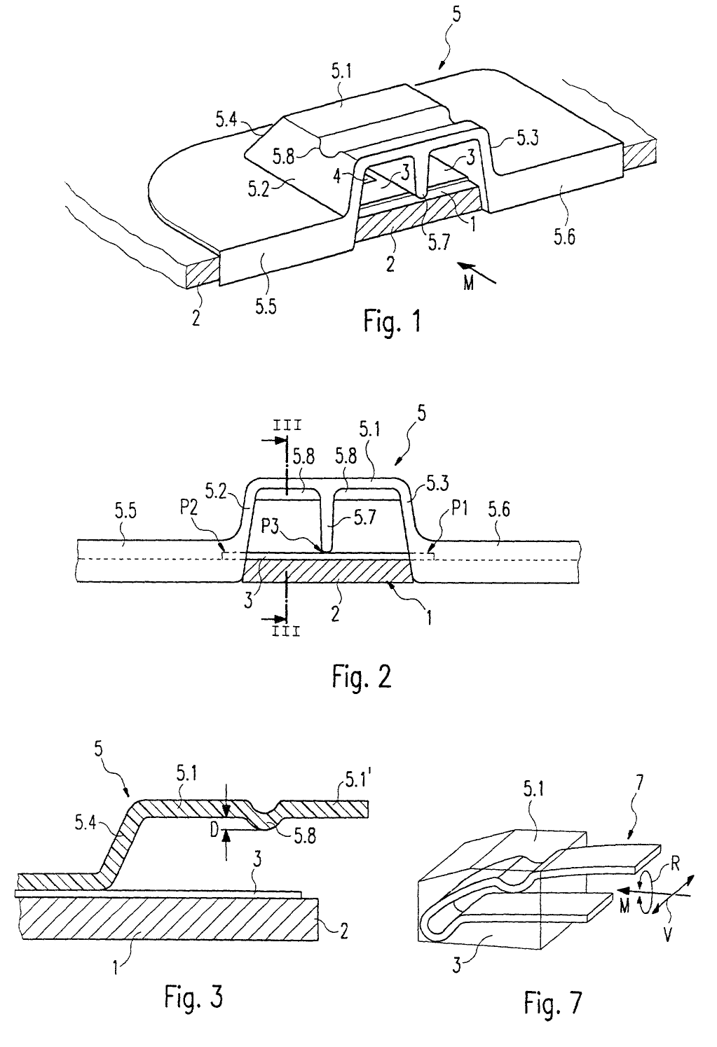

Referring now to the figures of the drawing in detail and first, particularly, to FIGS. 1 and 2 thereof, there is shown a base body embodied as a supporting plate 1. The base body has an edge 2 to which a flexible printed circuit board 3 which has been applied as a lamination (i.e. bonded) on the supporting plate 1 extends. The flexible printed circuit board is composed of two thin plastic films between which a structured conductor track foil is embedded. Contacting points 4 of the flexible printed circuit board can be implemented by means of openings in the upper plastic film (i.e. facing away from the supporting plate 1) which expose the metal conductor tracks. The exposed conductor tracks can additionally be provided with a metal coating, and in this case the contacting point 4 is also referred to as a contact pad.

A plug-in connector housing 5 is attached to the supporting plate 1 by way of suitable attachment means, for example screws, rivets, or mechanically loadable press-in connections. The plug-in connector housing 5 is preferably composed of a dimensionally stable hard plastic material. It comprises a box-shaped housing section with a cover part 5.1, side walls 5.2, 5.3, rear wall 5.4 and housing base sections 5.5 and 5.6 which adjoin the side walls 5.2 and 5.3 and run parallel to the supporting plate 1 and to the flexible printed circuit board 3 attached thereto.

The plug-in connector housing 5 is open in the vicinity of the edge 2 of the supporting plate 1 because, as explained in more detail below, the contact springs of the electrical component with which contact is to be made can be inserted from there into the housing. The mounting direction is indicated by the arrow M.

The plug-in connector housing 5 is embodied in the exemplary embodiment as a double chamber housing for holding two contact springs. The two chambers are formed by a dividing rib 5.7 which extends from the cover part 5.1 to the supporting plate 1.

In FIG. 2 it is apparent that the plug-in connector housing 5 additionally secures the flexible printed circuit board 3 in the junction regions between the side walls 5.2, 5.3 and the base regions 5.5, 5.6 and by means of the dividing rib 5.7. The corresponding pressing-on regions are represented in FIG. 2 by the reference symbols P1, P2 and P3.

A latching projection 5.8 which projects into the interior of the housing is formed in the cover part 5.1 of the plug-in connector housing 5. The latching projection 5.8 extends transversely with respect to the mounting direction M over both housing chambers. The height of the projection is referred to by D.

FIG. 3 shows a sectional view along the line III-III in FIG. 2 of the exemplary structure. It is apparent from FIG. 3 that an end region 5.1′ on the opening side of the cover part 5.1 protrudes a significant distance beyond the edge 2 of the supporting plate 1.

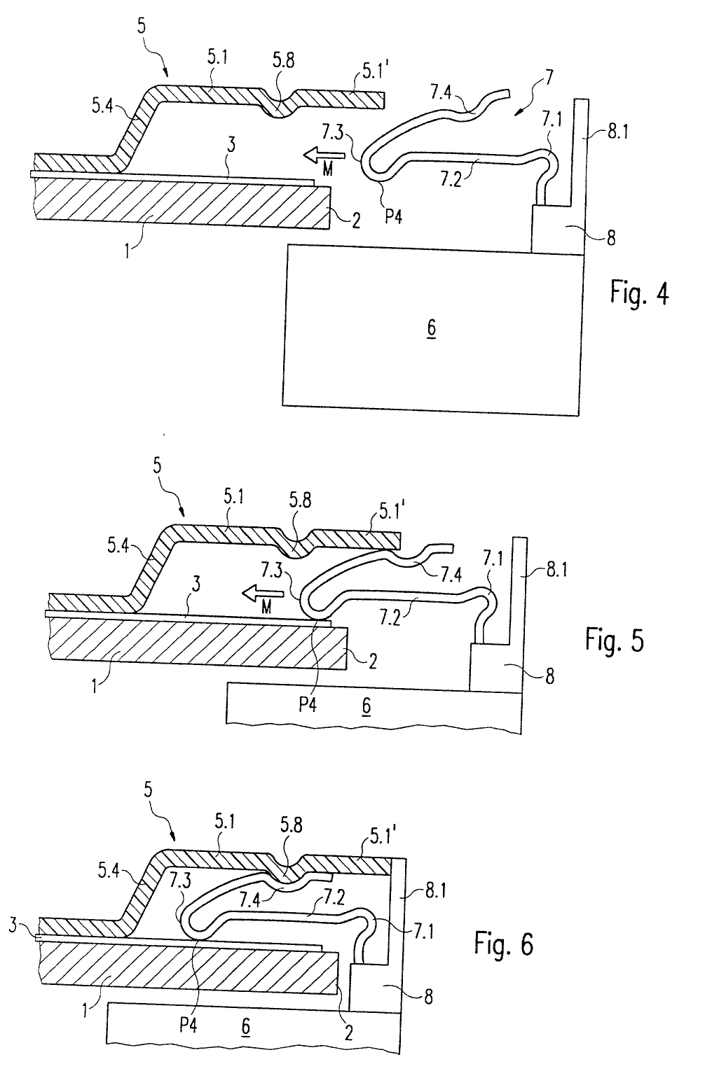

FIGS. 4 to 6 clarify the function of the plug-in connector housing 5 when a solenoid valve 6 is mounted and electrical contact is simultaneously made with it. The solenoid valve 6 is a component of a hydraulic assembly of an automatic transmission of a motor vehicle, and it controls the throughput rate of hydraulic fluid in hydraulic ducts. Neither the solenoid valve 6 nor the ducts are illustrated in detail, so as not to unnecessarily complicate the illustration.

In order to make electrical contact, the solenoid valve has two contact springs 7 which protrude out of the valve body. The contact springs 7 are arranged one next to the other and are at a distance which corresponds to the width of the dividing rib 5.7. The installation procedure will be explained below with reference to one of the contact springs 7 and the corresponding one housing chamber.

The contact spring 7 protrudes out of the valve body from a pedestal element 8 which is fitted onto the solenoid valve 6. The contact spring 7 has, along its further course, a 90° bend 7.1 and an adjoining spring section 7.2 which runs essentially parallel to the installation direction M. The spring section 7.2 merges with a bend 7.3 which is initially directed obliquely with respect to the valve body 6 and then turns away from the valve body 6 by approximately 180°. In the further course of the contact spring 7, it has a latching section 7.4 towards its free end. The profile of the latching section 7.4 is complementary to the shape of the latching projection 5.8.

With reference to FIG. 4, a point P4 (seen as a point in the elevational view, but in fact forming a contact zone or a line along the width of the spring 7) of the bend 7.3 which is lowest or nearest to the valve body during the mounting procedure is at a height which is either above the height of the surface of the flexible printed circuit board 3 or comparable therewith. The result of this is that the point P4 firstly either makes no contact at all with the flexible printed circuit board 3 or makes contact with it only with a very low initial pressure so that the flexible printed circuit board 3 is definitely prevented from being pushed or forced away by the contact spring 7.

In the course of the mounting operation, the spring section which is bent back comes to bear against the protruding region 5.1′ of the cover part 5.1 just before the latching sections 7.4. The contact spring 7 can, if appropriate, already be in contact with the cover part 5.1 if the point P4 of contact spring 7 is not yet located above the flexible printed circuit board 3 in the installation direction M. However, it is essential that the deflection of the contact spring 7 on the cover part 5.1 does not given rise to a build-up in pressure at the point P4 of the contact spring 7 until the contact zone (point P4) of the contact spring 7 is already located over the flexible printed board 3 (and not in front of it with respect to the mounting direction M).

In this way, there is a continuous increase in pressing-on force with the displacement in the direction M starting from the position of the contact spring 7 illustrated in FIG. 5 in the opening region of the plug-in connector housing 5 to the final installation position of the contact spring 7 (illustrated in FIG. 6) in the housing 5 until the desired (high) final pressure is reached. The U-shaped form of the contact spring is favorable here because it permits both a gradual build up of pressure during the pressing-in procedure and the definite final pressure in the installed position (FIG. 6).

In the installed position, the latching projection 5.8 engages in the latching section 7.4 of the contact spring 7, as a result of which, on the one hand the pressing-on force which is dependent on dimension D is set and, on the other hand, the contact spring 7 is mechanically stabilized in the plug-in connector housing 5. At the same time, an end plate 8.1 provided on the pedestal element 8 in the rear region of the contact spring 7 closes off the plug-in connector housing chamber, thus preventing metal turnings or the like being able to penetrate into the chamber during later operation.

With reference to FIG. 7, there is shown a schematic perspective phantom view of the contact spring 7 in a chamber of the plug-in contact housing. As already mentioned, the side walls 5.2, 5.3 and the dividing rib 5.7 are dimensioned and spaced apart in such a way that the chamber engages around the contact spring 7 without lateral movement play. This ensures that the position of the contact spring 7 remains largely uninfluenced even in the event of the occurrence of a rotation (circular arrow R) or a lateral displacement (double arrow V) of the contact spring 7 with respect to the mounting direction M.

In summary, the plug-in connector housing 5 according to the invention significantly improves the reliability of mounting and markedly increases the reliability with which contact is made during the operation of an electrical component in an engine or a transmission of a motor vehicle.

We claim:

1. A configuration for forming a contact between an electrical component and a flexible printed circuit board secured on a base body and extending to an edge of the base body, the configuration comprising:
a plug-in connector housing attached to the base body and having a housing opening formed toward the edge of the base body;
a contact spring formed with a contact zone for making contact with the printed circuit board, said contact spring supported on the electrical component and defining a mounting direction wherein said contact spring and the flexible printed circuit board are brought together when assembling the configuration, the mounting direction extending substantially parallel to a plane of the printed circuit board;
a stop element disposed on said plug-in connector housing above the flexible printed circuit board and shaped to engage over said contact spring as said contact spring is moved toward said stop element and to press said contact spring onto the flexible printed circuit board, whereby, during insertion of said contact spring into said housing opening, a pressure on said contact zone of said contact spring is substantially not built up until said contact zone is already located above the flexible printed circuit board, and
said plug-in connector housing having side walls dimensioned to straddle said contact spring substantially free of play.

2. The configuration according to claim 1, wherein said contact spring has a U-shaped profile.

3. The configuration according to claim 1, wherein said stop element forms a cover part of said plug-in connector housing.

4. The configuration according to claim 1, wherein said stop element projects beyond the edge of the base body.

5. The configuration according to claim 1, wherein said stop element and said contact spring are formed with interacting, complementary latching devices.

6. The configuration according to claim 1, which further comprises a closure element, configured to substantially completely close off said housing opening of said plug-in connector housing in an assembled state, formed at a base region of said contact spring.

7. The configuration according to claim 1, wherein said contact spring is one of a plurality of contact springs each provided for making contact with the electrical component, and said plug-in connector housing is formed with a multi-chamber housing.

8. The configuration according to claim 1, wherein said spring and said plug-in connector housing are configured to support a component of an engine or a transmission.

9. The configuration according to claim 1, wherein said spring and said plug-in connector housing are configured to support a solenoid valve in a motor vehicle.
